(19) United States
(12) Patent Application Publication
(10) Pub. No.: US 2022/0097275 A1
(43) Pub. Date: Mar. 31, 2022

(54) Method for Producing an Abrasion- and Water-Resistant Multilayer Panel and a Panel Which is Produced Using Said Method

(71) Applicant: Flooring Technologies Ltd., Kalkara (MT)

(72) Inventors: Norbert Kalwa, Horn-Bad Meinberg (DE); Torsten Kopp, Marnitz (DE)

(21) Appl. No.: 17/425,054

(22) PCT Filed: Jan. 8, 2020
(86) PCT No.: PCT/EP2020/050299

§ 371 Date: Jul. 22, 2021

(30) Foreign Application Priority Data
Jan. 23, 2019 (EP) 19153170.6

(51) Int. Cl. B29C 48/07; B29C 48/154

(52) U.S. Cl. CPC B29C 48/07; B32B 27/08; B29C 48/154

(57) ABSTRACT

Provided a method for manufacturing an abrasion- and water-resistant multilayer panel, in particular an abrasion- and water-resistant flooring panel, including the steps: providing at least one plastic carrier plate, in particular a PVC carrier plate; applying at least one decorative layer to the at least one plastic carrier plate; applying at least one primer layer to the at least one decorative layer; and uniformly scattering abrasion-resistant particles onto the at least one primer layer applied to the decorative layer applying at least one cover layer.

### CROSS-REFERENCE TO RELATED APPLICATIONS

This application is the U.S. national phase of International Application No. PCT/EP2020/050299 filed Jan. 8, 2020, and claims priority to European Patent Application No. 19153170.6 filed Jan. 23, 2019, the disclosures of which are hereby incorporated by reference in their entirety.

### BACKGROUND OF THE INVENTION

### Field of the Invention

The present invention relates to a method for producing an abrasion-resistant and waterproof multilayer panel, a panel produced by this method and a production line for carrying out this method.

### Description of Related Art

Currently, the main floor coverings used are ceramic tiles, wood coverings (such as parquet floors), laminate, PVC coverings, but also textile floor coverings (such as carpet). Flooring made of PVC is often preferred in public and commercial places, but also in the home due to its resistant properties, ease of installation and low cost.

Floor coverings based on PVC are divided into several categories and subcategories. In particular, a distinction is made between traditional PVC flooring and the so-called LVT (Luxury Vinyl Tile) flooring.

Traditional PVC flooring essentially uses PVC as a base material with plasticizers, resulting in a flexible product that can be easily printed and placed on a floor. Traditional PVC products are among the most cost-effective floor coverings currently available.

The LVT products include, among others, PVC coverings and multilayer floor coverings, which have a hard core and are in turn divided into two classes. These include, on the one hand, WPC products (WPC=wood plastic composites or waterproof plastic composites), which originally comprise a layer of a wood-plastic mixture as the core layer. In addition to the use of wood to reduce costs, foaming the substrate can also be an alternative. its

[symbol]

On the other hand, multi-layer PVC flooring includes SPC flooring, the core layer of which consists of a plastic component (usually PVC) and a larger proportion of minerals. Due to the greater proportion of minerals, the stiffness, weight and density is higher.

The production of SPC floor coverings (SPC=stone plastic composite) has been growing strongly in terms of volume in recent years. In the simplest case, the product consists of a carrier, a decorative layer and a wear layer.

The carrier consists of a highly filled thermoplastic, such as polyvinyl chloride or polypropylene, with chalk or talc usually used as fillers. The decorative layer is usually a printed thermoplastic film, which also has PVC or PP as its material base. In the simplest case, the wear layer is a transparent, thermoplastic film (PVC or PP).

During production, the carrier is first produced in an extruder, and directly afterwards the decorative and wear films are calendered on. The surface structure of the product is created by the structuring of the calender. The higher the desired wear class is to be, the thicker the wear film must be. This not only leads to cost disadvantages, but also to transparency problems with the higher wear classes.

The products to which the technology known to date refers comply, for example, with the requirements described in DIN EN 16511:2015 “Panels for floating installation—Semi-rigid, multilayer modular floor coverings (MMF) with abrasion-resistant top layer” or ISO 10582:2017 “Heterogeneous poly(vinyl chloride) floor coverings—Specifications”. These standards describe products that ensure their wear resistance essentially through the thickness of the wear layer. In ISO 10582, for example, a wear layer thickness of at least 0.8 mm is required for utilisation class 34. The reason for this high film thickness is that the wear resistance of unfilled PVC films is known, so that requirements are no longer defined by concrete testing. Such thicknesses of the wear layer reduce the color impression, especially with dark decors. In addition, the print looks more and more plastic-like due to the thick transparent layer.

To solve these problems, US 2018/0339504 A1 or WO 2018/217158 A1, for example, describe the application of a duplicated film to a substrate, with abrasion-resistant particles intercalated between the two films. The production of the doubled film with the embedded abrasion-resistant particles is carried out in a separate production line, and the doubled abrasion-resistant film is typically stored temporarily before further processing. The doubled film is then pressed or calendered onto a substrate (e.g. a PVC substrate). Here, too, the use of two films as a wear layer does not achieve a cost-optimal result.

The approaches known so far for the production of abrasion- and water-resistant panels lead to products with poor transparency and, due to the complex manufacturing process, to higher costs.

### SUMMARY OF THE INVENTION

The proposed solution is therefore based on the technical problem of providing a method for producing an SPC floor covering in which the wear layer is produced more efficiently. At the same time, the technical properties should not deteriorate and no other product deteriorations should occur. The productivity of the production line should also not be impaired by the method.

The object is solved by a method having features as described herein, a panel produced by this method having features as described herein, and a production line having features as described herein.

Accordingly, there is provided a method of manufacturing an abrasion- and water-resistant multilayer panel, in particular an abrasion- and water-resistant floor panel, comprising the following steps:
Providing at least one plastic carrier plate,
Applying at least one decorative layer to the at least one plastic carrier plate;
Applying at least one primer layer to the at least one decorative layer;
uniformly scattering abrasion-resistant particles onto the at least one primer layer applied to the decorative layer; and
Applying at least one cover layer.

Accordingly, the present method makes it possible to provide an abrasion- and water-resistant multilayer panel in various formats with high wear resistance in a cost-effective manner. The abrasion-resistant particles are scattered directly onto the primer layer applied to the decorative layer to form an abrasion-resistant layer, onto which a cover layer is in turn applied. The primer layer does not constitute a cover layer in the sense of the proposed solution; rather, an additional cover layer is provided. A further intermediate layer produced in a separate production step, in which the abrasion-resistant particles are embedded (as described in WO 2018/217158 A1), is not necessary.

In one variant, which will be described in detail later, corundum powder is scattered onto the decorative film as an abrasion-resistant material, followed by covering with a thin, transparent, thermoplastic film or a coating structure. A primer can be applied to the decorative film for better fixation of the corundum particles, which can also improve the adhesion of the layers applied later (film or coating). This means that products for higher wear classes can also be manufactured with a “thinner” wear layer, resulting in a significant improvement in transparency. In addition, of course, there is also a material saving.

In one embodiment of the present method, the plastic carrier plate is provided as a continuous strand and cut to size after coating.

The plastic carrier plate (or SPC core) can be made of various thermoplastics, such as polyvinyl chloride (PVC) or polypropylene (PP), with PVC being the preferred plastic.

In one embodiment of the present method, the plastic carrier plate is first produced as a continuous strand by extrusion of a mixture containing PVC, limestone and optional auxiliaries.

The mixture to be extruded can be provided in various alternatives. In one variant, the mixture to be extruded can be provided in the form of a powder, with the various ingredients being mixed in a mixing device to form a powdery mixture which, after optional intermediate storage, is introduced into the extruder.

In another variant, the mixture is provided in the form of a compound. The compound consists of the individual components which have already been melted together once and are then comminuted to form processable particles (e.g. pellets) which are fed into the extruder device.

Accordingly, a mixing device, intermediate hopper and melting device can be dispensed with when using a compound,

In one embodiment, the mixture to be extruded comprises 20-40 wt % PVC, preferably 25-35 wt % PVC, 60-80 wt % limestone, preferably 65-75 wt % limestone, and optionally other auxiliary materials. In a preferred embodiment, the mixture to be extruded comprises 65 wt % limestone (chalk) and 35 wt % PVC.

When starting from powdered raw materials, the particle size of the limestone should be similar to the particle size of the PVC powder. This facilitates the production of the powder mixture and avoids segregation or inhomogeneities. Of course, this also applies to the production of the compound.

Stabilizers, waxes, lubricants, release agents and other auxiliaries can be added as additives. A preferred stabilizer comprises Ca—Zn and can be added in an amount between 1 and 3 wt %, preferably 2 wt % of the compound to be extruded. PE waxes can be used as waxes. Preferred release agents are CPE release agents, which are used in an amount between, 0.5 and 1.5 wt %, preferably 1 wt % in the mixture to be extruded,

The abbreviation CPE stands for chlorinated polyethylene, a copolymer of ethylene and vinyl chloride. Depending on the ratio of the two monomers, the chlorine content in the polymer can vary, unlike in PVC. CPE is used, among other things, as an agent to increase impact strength.

The extrusion of the compound takes place in an extruder with discharge of a sheet-like strand. As mentioned above, the mixture of PVC, CaCO₃ or limestone and other additives to be extruded is either prepared in advance by mixing the ingredients as powder, or as a finished compound.

The mixture to be extruded then passes through a multi-stage extruder with zones of different temperature, with partial cooling with water. The mixture to be extruded is elastified in the extruder under the influence of temperature and shear force to form a “kneadable” mass. A sheet-like strand (e.g. with a maximum width of 1,400 mm) is discharged from the extruder via a slot die onto a roller conveyor and further processed (refined). The transport speed of the continuous strand is selected in such a way that the continuous strand does not cool down, but rather still has a temperature that allows the subsequent layers, in particular in the form of thermoplastic films, to be calendered.

In an embodiment, a decorative film, in particular a PVC decorative film, is applied, in particular calendered, to the plastic carrier plate as the decorative layer. The PVC decorative film is produced separately and can have a basis weight of between 60-100 mg/m², preferably 80 g/m². The PVC decorative film is applied by online feeding of the PVC decorative film (produced separately) from a roll, which is calendered onto the carrier plate without any further auxiliary materials using the thermal energy present in the carrier plate.

For the purposes of the present application, the term “calendering” is to be understood as the application of a thermoplastic film to a (still warm) carrier plate using heated rollers. This results in melting of the surface of the thermoplastic film, which, after curing, is bonded or welded to the carrier board at the surface and thus adheres to the carrier board. Accordingly, no gluing is necessary.

As explained above, at least one primer layer is applied to the decorative layer, in particular to the decorative film. The primer layer preferably contains polyurethane. The PU-based primer can be rolled or sprayed onto the decorative layer in an amount of between 10 and g/m², preferably 15 g/m² (liquid). The use of a primer layer is advantageous because improved adhesion of the subsequently spread particles and the subsequently applied layers (film or paint) is achieved.

In a further embodiment of the present method, abrasion resistant particles, particles of corundum (aluminum oxides), boron carbides, silicon dioxides, silicon carbides are used. Particles of corundum are particularly preferred. Preferably, these are high-grade (white) corundum with a high transparency, so that the optical effect of the underlying decor is adversely affected as little as possible. Corundum has an irregular spatial shape.

The amount of scattered abrasion-resistant particles is 10 to 50 g/m², preferably 10 to 30 g/m², in particular preferably 15 to 25 g/m². The amount of scattered abrasion-resistant particles depends on the abrasion class to be achieved and the particle size. Thus, in the case of abrasion class AC3, the amount of abrasion-resistant particles is in the range between 10 to 15 g/m², in abrasion class AC4 between 15 to 20 g/m², and in abrasion class AC5 between 20 to 25 g/m² when using grit size F220. In the present case, the finished boards preferably have abrasion class AC4.

Abrasion resistant particles with grain sizes in classes F180 to F240 are used. The grain size of class F180 covers a range of 53-90 μm, F220 from 45-75 μm, F230 34-82 μm, F240 28-70 μm (FEPA standard). In a particularly preferred embodiment, corundum particles of class F220 are used.

The abrasion-resistant particles must not be too fine-grained (risk of dust formation), but also not too coarse-grained. The size of the abrasion-resistant particles is thus a compromise.

In a more advanced embodiment, silanized corundum particles may be used. Typical silanizing agents are aminosilanes, methacrylic silanes, monomeric or oligomeric alkyl silanes. Silanization of the corundum particles enables improved adhesion (“docking”) of the corundum particles to the layers provided, such as decorative film and/or primer layer.

In one embodiment of the present method, a cover film made of a thermoplastic material such as PVC, PET or PU, in particular a transparent PVC film, is then applied, in particular calendered, to the scattered layer of abrasion-resistant particles as a cover layer. For this purpose, a transparent PVC film with a basis weight of between 40 and 60 g/m², preferably 50 g/m², can be calendered onto the structure comprising the backing sheet, decorative film and abrasion-resistant particles. The transparent PVC film is produced separately and fed online from a roll. Calendering is preferably carried out with a textured roll to which temperature is applied. In general, it is also conceivable that a structure (EIR) running synchronously with the decor is realized. Accordingly, a structured cover layer, preferably structured cover film, can be provided on the panel.

Furthermore, at least one lacquer layer, in particular at least one polyurethane lacquer layer, can be applied to the cover film to improve scratch resistance and adjust the gloss level. The lacquer layer may contain nanoparticles, e.g. of silica. The coating, preferably a PU lacquer or UV lacquer, can be applied in an amount of between 40 and 60 g/m², preferably 50 g/m², by means of further rollers.

In an alternative embodiment, a lacquer structure comprising at least one lacquer layer and at least one top lacquer (instead of a cover film and possibly UV coating) is applied as a cover layer to improve scratch resistance. The top lacquer may contain nanoparticles, e.g. of silica. No solvent-based lacquers are used.

Radiation-curable acrylate-containing coatings are used in particular for the lacquer layer and the top lacquer. Typically, the radiation-curable lacquers used contain (meth)acrylates, such as polyester (meth)acrylates, polyether (meth)acrylates, epoxy (meth)acrylates or urethane (meth)acrylates. It is also conceivable that the acrylate used or the acrylate-containing lacquer is substituted or unsubstituted monomers, oligomers and/or polymers, in particular in the form of acrylic acid, acrylic ether and/or acrylic acid ester monomers, oligomers or polymers. Of importance for the present method is the presence, as defined, of a double bond or unsaturated group in the acrylate molecule. The polyacrylates may also be further functionalized. Suitable functional groups include hydroxy, amino, epoxy and/or carboxyl groups. The aforementioned acrylates allow crosslinking or curing in the presence of UV or electron beams (ESH).

The varnish layer is applied in an amount between 50 and 100 g/m², preferably between 60 and 80 g/m², while the top lacquer is applied in an amount between 10 and 30 g/m², preferably 30 g/m². The lacquer structure may consist of at least one ESH lacquer layer, which is pre-gelled after application with an ESH emitter, and at least one top lacquer, which is pre-cured after application with excimer emitters. The entire lacquer structure is finally cured with an ESH emitter. Instead of the lacquer build-up described, a hot-coating application (e.g. PU paint) can also be used to cover the abrasion-resistant particles.

It is also possible and conceivable that a structure is introduced into the lacquer structure as a covering layer using a structure-imparting roller or a mechanical press element (pressing device).

In a further embodiment, a backing, in particular for impact sound insulation, can be applied to the underside of the plastic carrier plate, in particular laminated on.

In the further process sequence, the multilayer structure consisting of plastic carrier plate, decor layer, abrasion-resistant particles, cover layer and, if necessary, backing sheet is cooled, e.g. using a blower or a water bath, and then cut to length (cutting to length), the cut being matched to a panel length for the production of half-formats, which are placed decor on decor on top of one another and stacked. It is also possible for the surface of the half-size sheets to be coated with UV coating for further adjustment of the abrasion and/or gloss level. In a further process, the half-size formats are divided into panels, e.g. by die cutting.

The panels can be profiled lengthwise and crosswise on automatic milling machines, but separately, so that the milling waste can be recycled.

Optionally, the panel is provided with a V-joint in the longitudinal and/or transverse direction, which is lacquered.

In a further embodiment of the present method, a lockable tongue-and-groove joint is introduced at at least two opposite edges of the panel. This enables simple and fast floating installation of the panels. Such tongue-and-groove joints are known from EP 1 084 317 B1, among others.

The present method thus enables the production of an abrasion-resistant and waterproof multilayer panel having the following structure (from bottom to top):
at least one plastic carrier plate, in particular a PVC carrier plate;
at least one decorative layer on the at least one plastic carrier plate;
at least one primer layer on the at least one decorative layer;
at least one layer of scattered abrasion resistant particles on the at least one primer layer; and
at least one cover layer,
wherein the at least one plastic carrier plate and the layers applied thereto are bonded together by means of calendering.

The abrasion-resistant and waterproof panels have a bulk density between 1500 and 3000 kg/m³, preferably 2000 and 2500 kg/m³. The total thickness of the panels is less than 6 mm, between 4 and 6 mm, preferably 4 and 5 mm.

In a first embodiment, the multilayer panel has the following layered structure:
at least one plastic carrier plate, in particular a PVC carrier plate;
at least one decorative film as a decorative layer on the at least one plastic carrier plate;
at least one primer layer on the at least one decorative film;
at least one layer of scattered abrasion resistant particles on the at least one primer layer; and
at least one cover film as a covering layer.

In another second embodiment, the multilayer panel may have the following layered structure:
at least one plastic carrier plate, in particular a PVC carrier plate;
at least one decorative film as a decorative layer on the at least one plastic carrier plate;
at least one primer layer on the decorative film;
at least one layer of scattered abrasion resistant particles on the at least one primer layer; and
at least one cover film as cover layer, wherein at least one lacquer layer is provided on the cover film.

Also, in the above embodiments of the panel, the cover film may be present in a structured form. Thus, the cover film can preferably have a structure (EIR) running synchronously with the decor.

In the above embodiments of the panel, a lacquer layer (UV lacquer) may additionally be provided on the cover film to improve scratch resistance and adjust the gloss level.

In a still further embodiment, the multilayer panel has the following layered structure:
at least one plastic carrier plate, in particular a PVC carrier plate;
at least one decorative film as a decorative layer on the at least one plastic carrier plate;
at least one primer layer on the decorative film;
at least one layer of scattered abrasion resistant particles on the at least one primer layer; and
at least one coating structure consisting of at least one coating layer and at least one top coat as a covering layer.

The production line for carrying out the present method includes the following elements:
at least one extruder device for providing a plastic carrier plate, in particular as a continuous strand;
at least one device for applying at least one decorative layer to the at least one plastic carrier plate;
at least one device for scattering a predetermined amount of abrasion-resistant particles, arranged downstream of the at least one device for applying at least one decorative layer; and
at least one device arranged downstream of the spreading device in the processing direction for applying at least one covering layer to the spread abrasion-resistant particles.

In one variant of the present production line, at least one mixing device is provided for mixing the starting materials for the plastic carrier plate in the processing direction upstream of the extruder device. In the mixing device, the thermoplastic, in particular PVC, limestone and other additives are mixed together.

In a more advanced variant, the production line comprises at least one intermediate hopper arranged downstream of the mixing device for storing the mixture of plastic, limestone and other additives. The intermediate hopper is adjoined by the extrusion device in the processing direction.

It is also possible to dispense with the mixing device and intermediate hopper. In this case, a finished compound is provided from the starting materials (e.g. in the form of pellets) and fed into the extruder.

The compound is fed into the extruder, subjected to shear forces in the extruder. subjected to shear forces, thereby elasticized and pressed through a profile to form a continuous strand (SPC strand).

The extruder is followed in the processing direction by at least one device for applying a decorative layer, in particular in the form of a decorative film. Preferably, the decorative film is continuously fed online via a roll and calendered onto the still warm continuous strand using a calender or a calendering device (consisting of at least one roll).

In a preferred embodiment, at least one application device, in particular in the form of a roller application device or a spray unit, for applying a primer layer to the decorative layer is provided downstream of the device for applying a decorative layer in the processing direction.

The scattering device for the abrasion-resistant particles provided in the present production line is suitable for scattering powder, granules, fibers and comprises an oscillating brush system. The scattering device consists essentially of a supply hopper, a rotating, structured roller and a scraper. Here, the rotational speed of the roller is used to determine the amount of abrasion-resistant material applied. The spreading device preferably comprises a spiked roller.

In one embodiment of the present production line, it is further provided that the at least one spreading device is surrounded by or arranged in at least one booth, which is provided with at least one means for removing dusts occurring in the booth. The means for removing the dusts may be in the form of a suction device or also as a device for blowing in air. The blowing in of air can be achieved via nozzles installed at the plate inlet and outlet, which blow air into the booth. In addition, these can prevent air movements from creating an inhomogeneous scatter curtain of abrasion-resistant material.

The removal of dust from abrasion-resistant material from the environment of the scattering device is advantageous, because apart from the obvious health burden for the workers working on the production line, the fine dust from abrasion-resistant particles is also deposited on other equipment parts of the production line and leads to increased wear of the same. Therefore, the arrangement of the scattering device in a cabin serves not only to reduce the health impact of dust on the environment of the production line, but also prevents premature wear.

The spreading device is followed in the processing direction by the device for applying the at least one covering layer. This device is designed differently depending on the type of covering layer to be applied.

If a transparent PVC film is used as the cover layer, the PVC film is continuously fed online from a roll and calendered onto the abrasion-resistant particles scattered on the decorative layer using a calender or calendering device. The textured roll used for this purpose is temperature-controlled and allows simultaneous texturing and calendering of the PVC film. This can be followed by the application of a UV coating to adjust the gloss level by means of a suitable roller device.

If a coating structure comprising at least one coating layer and at least one topcoat is used as a covercoat, the coating layer(s) is/are applied using an applicator unit, in particular in the form of a single-sided applicator unit. The applicator is followed in the processing direction by devices for curing the coating structure, in particular ESH emitters and excimer emitters.

Suitable cooling devices and cutting devices are provided in for further fabrication.

### BRIEF DESCRIPTION OF THE DRAWINGS

The solution is explained in more detail below with reference to the figures in the drawings, using an example of an embodiment.

FIG. 1 shows a schematic representation of a production line of a multilayer panel according to a first embodiment of the method according to the solution

FIG. 2 shows a schematic representation of a production line of a multilayer panel according to a second embodiment of the method according to the solution.

### DESCRIPTION OF THE INVENTION

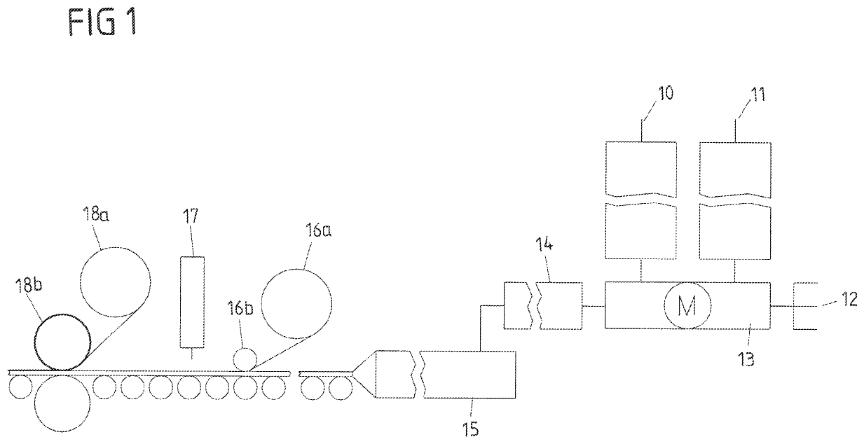

The production line shown schematically in FIG. 1 comprises a storage container 10 for PVC powder and a storage container 11 for limestone, which are mixed together in the mixing device 13 with the addition of further auxiliary materials 12.

This powdered mixture of PVC, limestone (or chalk) and further additives can be temporarily stored in an intermediate hopper 14. The intermediate hopper 14 is arranged downstream of the mixing device in the processing direction.

As already discussed, a compound made from the individual components in pellet form can also be used directly as the starting component for extruder 15. In this case, storage tanks 10, 11, 12, mixing device 13, and intermediate hopper 14 can be dispensed with.

The mixture (powder or compound) is fed into the extruder device 15 and pressed through a profile to form a continuous strand (SPC strand). The extruder device 15 is designed as a multi-stage extruder with zones of different temperature, with partial cooling with water. A sheet-like strand (e.g. with a maximum width of 1,400 mm) is discharged from the extruder via a slot die onto a roller conveyor for further processing.

Downstream of extruder 15 in the processing direction is a device for applying a decorative PVC film. This device comprises a roll 16a, via which the PVC decorative film is fed online, and a calendering roll 16b, via which the PVC decorative film is calendered onto the still warm continuous strand.

Downstream of the application device 16a, 16b for the PVC decorative film, a first scattering device 17 is provided for uniformly scattering the abrasion-resistant material such as corundum onto the decorative film on the upper side of the plastic carrier plate. The abrasion-resistant material used is corundum F220, which measures about 45-75 μm in diameter according to FEPA standards.

The spreading device 17 essentially consists of a supply hopper, a rotating, structured spiked roller and a scraper. The application quantity of the material is determined by the rotational speed of the spreader roller. Depending on the required abrasion class of the product, between 12-25 g/m² of corundum is spread onto the board (AC4 (according to EN 13329)=20 g/m²). From the spiked roller, the corundum falls at a distance of 5 cm onto the panel provided with the decorative film.

The spreading device 17 is followed in the processing direction by the device for applying a transparent PVC film as a cover layer. This device also comprises a roll 18a, via which the transparent PVC cover film is fed online, and a calendering roll 18b, via which the transparent PVC cover film is calendered on. The calendering roll 18b used is temperature-controlled and designed as a structure roll, so that simultaneous structuring and calendering of the PVC cover film is possible.

If a lacquer structure is used as a cover layer, the lacquer layer(s) is/are applied using an applicator unit. The applicator is followed in the processing direction by devices for curing the lacquer structure, in particular ESH emitters and excimer emitters (not shown).

Suitable cooling devices and cutting device in are provided for further fabrication (not shown).

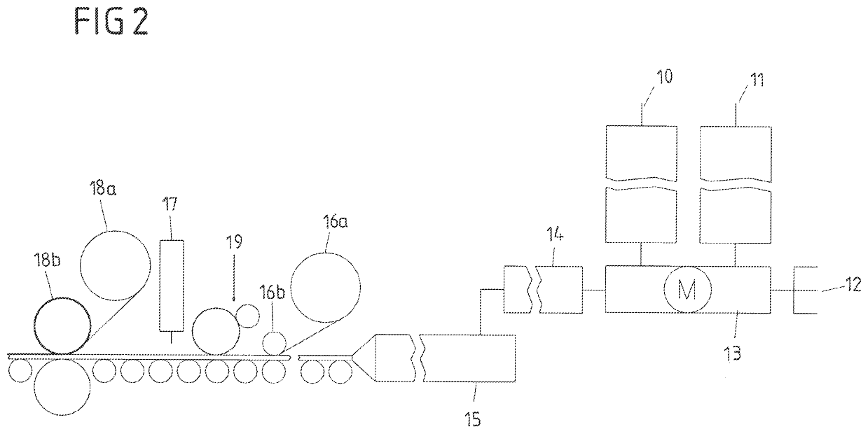

In addition to the elements and devices shown in FIG. 1 and described above, the production line shown in FIG. 2 comprises an applicator 19 for applying a PU primer layer to the PVC decorative film. The applicator 19 is provided downstream of the device for applying the PVC decorative film and can be designed as a roller applicator or spray unit.

### EXAMPLE 1

A compound consisting of approx. 65 wt % chalk and 35 wt % PVC was melted at approx. 140° C. in an extruder. The compound contained the usual auxiliaries, such as lubricants, antioxidants, etc. The compound was pressed through a profile with the dimensions 1300×4 mm with simultaneous cooling.

Then, in a first step, a decorative film was calendered on. This was a PVC film (approx. 80 g/m² basis weight) printed with a wood decor.

A corundum modified with an oligomeric alkyl silane (15 g corundum/m², grain size: F 220) was then scattered onto this with the aid of a spreader. A transparent PVC film (basis weight: 50 g/m²) was calendered onto this.

For comparison, a sample was produced without corundum but with a transparent PVC film (basis weight: 96 g/m²).

Both transparent films were structured by a structured calendering roll during calendering. The continuous strand is then cut to size. A PU coating (30 g coating/m²) or UV coating was still applied to both samples to improve scratch resistance and cured.

The abrasion resistance of both samples was then tested in accordance with DIN EN 13329, Appendix E. Both samples achieved service class 34 (>4000 um).

### EXAMPLE 2

A compound consisting of approx. 65 wt % chalk and 35 wt % PVC was melted at approx. 140° C. in an extruder. The compound contained the usual auxiliaries, such as lubricants, antioxidants, etc. The compound was pressed through a profile with the dimensions 1300×4 mm with simultaneous cooling.

Then, in a first step, a decorative film was calendered on. This was a PVC film (approx. 80 g/m² basis weight) printed with a wood decor.

A PU-based primer (approx. 15 g/m², liquid) was then rolled or sprayed onto the decorative film.

A corundum modified with an oligomeric alkyl silane (15 g corundum/m², grain size: F 220) was then scattered onto this with the aid of a spreader. A transparent PVC cover film (basis weight: 50 g/m²) was calendered onto this.

For comparison, a sample was produced without primer and corundum, but with a transparent PVC film (basis weight: 96 g/m²).

Both transparent films were structured by a structured calendering roll during calendering. The continuous strand is then cut to size. A PU coating (30 g coating/m²) or UV coating was still applied to both samples to improve scratch resistance and cured.

The abrasion resistance of both samples was then tested in accordance with DIN EN 13329, Appendix E. Both samples achieved service class 34 (>4000 um).

### EXAMPLE 3

A compound consisting of approx. 65 wt % chalk and 35 wt % PVC was melted at approx. 140° C. in an extruder. The compound contained the usual auxiliaries, such as lubricants, antioxidants, etc. The compound was pressed through a profile with the dimensions 1300×4 mm with simultaneous cooling.

Then, in a first step, a decorative film was calendered on. This was a PVC film (approx. 80 g/m² basis weight) printed with a wood decor.

A PU-based primer (approx. 15 g/m², liquid) was then rolled or sprayed onto the film. Corundum modified with a methacrylic silane was then sprinkled into the primer with the aid of a spreader (15 g corundum /m², grain size: F 220).

The continuous strand is then either cut to size or further processed as a continuous strand. A coating structure consisting of an ESH coating (60 g/m²) and a UV-based top coat to improve scratch resistance (20 g/m²) was applied to the surface. The first lacquer was pre-gelled with an ESH radiator. The top lacuer was pre-cured with an excimer emitter, resulting in a matte finish (<5 gloss points). The entire build-up was then cured with an ESH emitter.

For comparison, a sample was produced with a primer, an ESH coating (120 g/m²) and a topcoat to improve scratch resistance, also UV-based (20 g/m²). The first UV coating was annealed with an ESH lamp and then the topcoat was applied. This was cured with an excimer emitter, producing a matte surface (<5 gloss points). The entire structure was then cured with an ESH lamp.

Both samples were then tested for abrasion resistance according to DIN EN 15468: 2013 Annex A. Both samples achieved service class 34 (>7000 um).

Of course, other types of film can also be used to cover the corundum particles, such as PET, PU, etc. In addition to a coating, a hotcoating application can also be used for covering.

1. A method of manufacturing an abrasion and water resistant multilayer panel, in particular an abrasion and water resistant floor panel, comprising the steps of:
providing at least one plastic carrier plate, in particular a PVC carrier plate;
applying at least one decorative layer to the at least one plastic carrier plate;
application of at least one primer layer to the at least one decorative layer;
uniform scattering of abrasion-resistant particles onto the at least one primer layer applied to the decorative layer; and
applying at least one cover layer.

2. The method according to claim 1, wherein the plastic carrier plate is provided as a continuous strand and is cut to size after coating.

3. The method method according to claim 1, wherein the plastic carrier plate is produced by extrusion of a mixture comprising PVC, limestone and optional auxiliary materials.

4. The method according to claim 3, wherein the mixture to be extruded contains 20-40 wt % PVC, preferably 25-35 wt % PVC, 60-80 wt % limestone, preferably 65-75 wt % limestone, and optionally other auxiliaries.

5. The method according to claim 1, wherein a decorative film, in particular a PVC decorative film, is applied as the decorative layer to the plastic carrier plate, in particular by calendering.

6. The method according to claim 1, wherein at least one primer layer is applied to the decorative film.

7. The method according to claim 1, wherein the primer layer comprises polyurethane.

8. The method according to claim 1, wherein particles of corundum (aluminum oxides), boron carbides, silicon dioxides, silicon carbides are used as abrasion-resistant particles.

9. The method according to claim 1, wherein a cover film, in particular a transparent PVC cover film, is applied as cover layer, in particular calendered on.

10. The method according to claim 9, wherein, at least one lacquer layer, in particular at least one polyurethane lacquer layer, is applied to the cover film to improve the scratch resistance and to adjust the gloss level.

11. The method according to claim 1, wherein a lacquer structure comprising at least one lacquer layer and at least one top lacquer is applied as a covering layer.

12. The method according to claim 1, wherein a structure is introduced into the cover layer using a structure-imparting roller or a mechanical pressing element (pressing device).

13. The method according to claim 1, wherein a lockable tongue-and-groove joint is introduced at at least two opposite edges of the panel.

14. An abrasion-resistant and waterproof multilayer panel producible in a method according to claim 1 comprising:
at least one plastic carrier plate, in particular a PVC carrier plate;
at least one decorative layer on the at least one plastic carrier plate;
at least one primer layer on the at least one decorative layer;
at least one layer of abrasion resistant particles on the at least one primer layer; and
at least one cover layer, wherein
the at least one plastic carrier plate and the layers applied thereto are bonded together by means of calendering.

15. A production line for carrying out a method according claim 1 comprising
at least one extruder device for providing a plastic carrier plate, in particular in the form of a continuous strand;
at least one device for applying at least one decorative layer to the at least one plastic carrier plate;
at least one device for scattering a predetermined amount of abrasion-resistant particles, arranged downstream of the at least one device for applying at least one decorative layer; and
at least one device arranged downstream of the spreading device in the processing direction for applying at least one covering layer to the spread abrasion-resistant particles.
